(19) United States
(12) Patent Application Publication
(10) Pub. No.: US 2020/0248746 A1
(43) Pub. Date: Aug. 6, 2020

(54) INTEGRATED STUD BALL BEARING WITH PRECISION MATCHED RACEWAY CONTACT ANGLES FOR CONSISTENT STIFFNESS OF GIMBAL ASSEMBLY

(71) Applicant: Roller Bearing Company of America, Inc., Oxford, CT (US)

(72) Inventors: Alex Habibvand, Orange, CA (US); John H. Cowles, JR., Unionville, CT (US); Richard Murphy, Torrington, CT (US)

(73) Assignee: Roller Bearing Company of America, Inc., Oxford, CT (US)

(21) Appl. No.: 16/775,533

(22) Filed: Jan. 29, 2020

Related U.S. Application Data
(60) Provisional application No. 62/800,084, filed on Feb. 1, 2019.

(51) Int. Cl. F16C 25/06; F16C 19/18; F16C 33/49

(52) U.S. Cl. CPC F16C 25/06; F16C 2229/00; F16C 33/49; F16C 19/181

(57) ABSTRACT

A ball bearing assembly includes a one piece outer ring having a first and second outer race and an exterior surface; and a one piece inner ring having a first and second inner race, the inner ring is integrally formed on a shaft. A first plurality of balls is disposed between the first outer race and the first inner race; and a second plurality of balls is disposed between the second outer race and the second inner race. The first plurality of balls has a first contact and the second plurality of balls has a second contact angle.

### CROSS REFERENCE TO RELATED APPLICATION

This application claims the benefit of U.S. Provisional Patent Application Ser. No. 62/800,084 filed on Feb. 1, 2019, which is incorporated herein by reference in its entirety.

### FIELD OF THE INVENTION

The present invention is generally directed to precision ball bearing assemblies having an integral stud. More specifically, the present invention is directed to novel configurations that have a consistent and predictable axial, radial, and moment stiffnesses for use in gimbal assemblies and systems.

### BACKGROUND OF THE INVENTION

A gimbal is a pivoted support that allows the rotation of an object about a single axis. A set of three gimbals, one mounted on the other with orthogonal pivot axes, may be used to allow an object mounted on the innermost gimbal to remain independent of the rotation of its support. For example, on a ship, the gyroscopes, shipboard compasses, stoves, and even drink holders typically use gimbals to keep them upright with respect to the horizon despite the ship's pitching and rolling.

Consistent and predictable stiffness of bearings assembly utilized in a gimbal system has been difficult to achieve. Prior art bearings employed in a gimbal system such as a missile seeker head, have been found to have inconsistent stiffnesses. Missile launch platforms that have high levels of vibration such as fixed wing aircraft require gimbal systems also have been found to have inconsistent and unpredictable stiffnesses. Other systems such as those used for inertial navigation, rocket engines, photography and imaging, film and video, and marine chronometers have also been found to have inconsistent and unpredictable stiffnesses.

Therefore, there is a need for improved ball bearing assemblies that have a consistent and predictable stiffness for use in gimbal assemblies and other systems where consistent and predictable stiffness is critical.

### SUMMARY OF THE INVENTION

The present invention resides in one aspect in a gimbal ball bearing assembly that includes a one piece outer ring that has a first outer race, a second outer race and an exterior surface. The gimbal ball bearing assembly includes a one piece inner ring that has a first inner race and a second inner race. The inner ring is integrally formed on a shaft and is fixed relative to the shaft about a longitudinal axis. The inner ring is coaxial with the outer ring. A first plurality of balls is disposed between and in rolling engagement with the first outer race and the first inner race. A second plurality of balls is disposed between and in rolling engagement with the second outer race and the second inner race. The outer ring is rotatable relative to the inner ring about the longitudinal axis. The first plurality of balls has a first contact angle measured between a first line perpendicular to the longitudinal axis and a first reference line that connects opposing first contact points of the first plurality of balls with the first outer race and the first inner race. The second plurality of balls has a second contact angle measured between a second line perpendicular to the longitudinal axis and a second reference line that connects opposing second contact points of the second plurality of balls with the second outer race and the second inner race.

In one embodiment, the first contact angle and/or the second contact angle is about 25 degrees to about 35 degrees.

In one embodiment, the first contact angle and/or the second contact angle is about 27 degrees to about 33 degrees.

In one embodiment, the first contact angle and/or the second contact angle is about 29 degrees to about 31 degrees.

In one embodiment, the first contact angle and the second contact angle is about 30 degrees

In one embodiment, the first outer race and the second outer race are configured to impart an axial preload of about pounds to about 35 pounds to the first of balls against the first inner race and to the second plurality of balls against the second inner race.

In one embodiment, the first outer race and the second outer race are configured to impart an axial preload of about 15 pounds to about 30 pounds to the first of balls against the first inner race and to the second plurality of balls against the second inner race.

In one embodiment, the first plurality of balls has a pitch diameter defined by a distance between the longitudinal axis and a ball central axis. A ratio of the pitch diameter to a thickness of the outer ring is about 600% to about 800%.

In one embodiment, an outer ring outside diameter of the outer ring is defined between an exterior surface of the outer ring and the longitudinal axis. A ratio of the outer ring outside diameter to the pitch diameter is about 120% to about 140%.

In one embodiment, the first inner race and the second inner race have a common inner race outside diameter.

In one embodiment, the ball bearing assembly has an axial stiffness of about 257, 990 lbf/in to about 390,810 lbf/in.

In one embodiment, the ball bearing assembly has a radial stiffness of about 377,360 lbf/in to about 502,520 lbf/in.

In one embodiment, the ball bearing assembly has a moment stiffness of about 6,849 in-lbf/rad to about 12,932 in-lbf/rad.

### DESCRIPTION OF THE DRAWINGS

FIG. 1 is an isometric view of an integrated stud ball bearing in accordance with one embodiment of the present invention.

FIG. 2 is top view of some of the elements of integrated stud ball bearing shown in FIG. 1.

FIG. 3 is side view of some of the elements of the integrated stud ball bearing shown in FIG. 1.

FIG. 4A is a cross-sectional view of the integrated stud ball bearing shown in FIG. 3 at section A-A.

FIG. 4B is another cross-sectional view of the integrated stud ball bearing shown in FIG. 3 at section A-A.

FIG. 5 is an isometric view of the bearing retainer shown in FIG. 4.

FIG. 6 is a graph of the axial stiffness sensitivity of the present invention versus the contact angle.

FIG. 7 is a graph of the radial stiffness sensitivity of the present invention versus the contact angle.

FIG. 8 is a graph of the moment stiffness sensitivity of the present invention versus the contact angle.

### DETAILED DESCRIPTION OF THE INVENTION

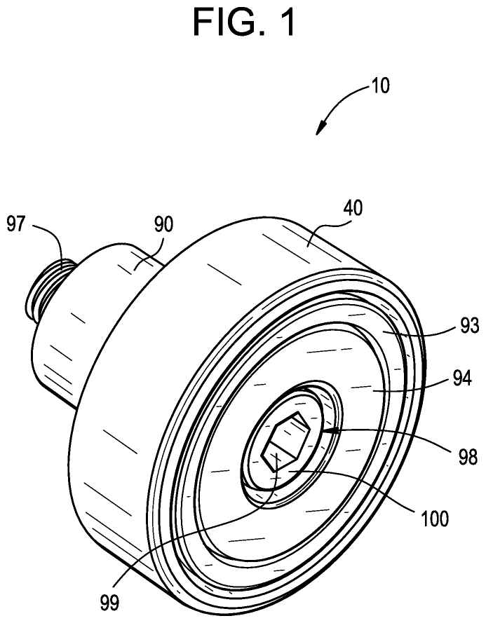

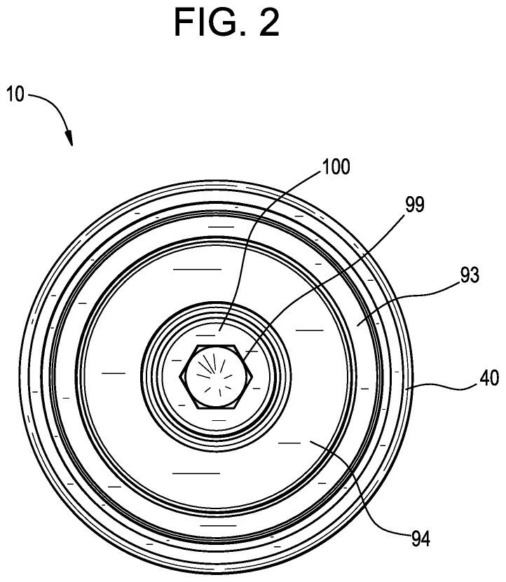

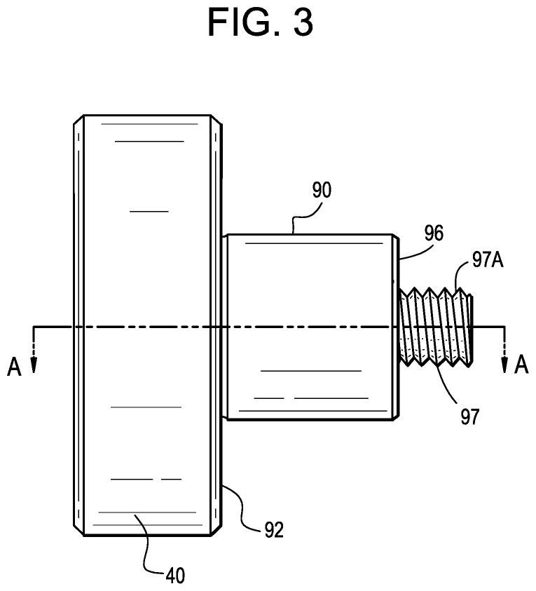

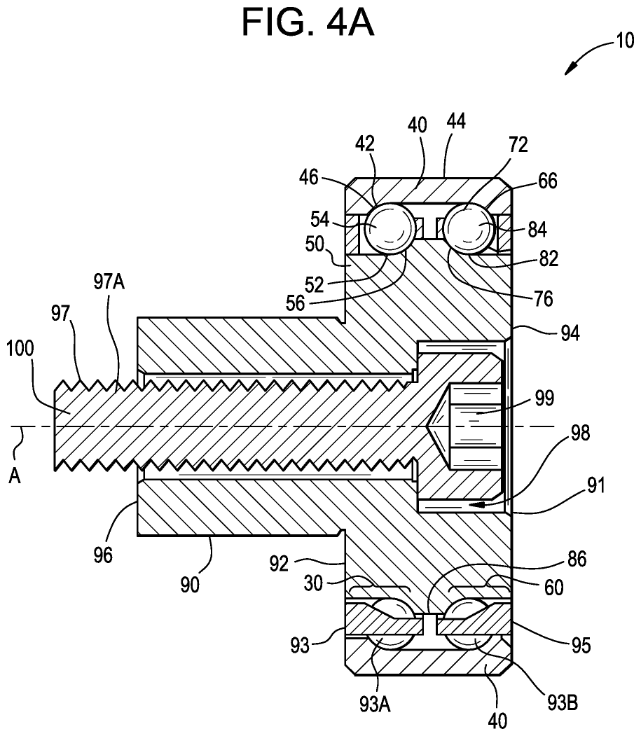

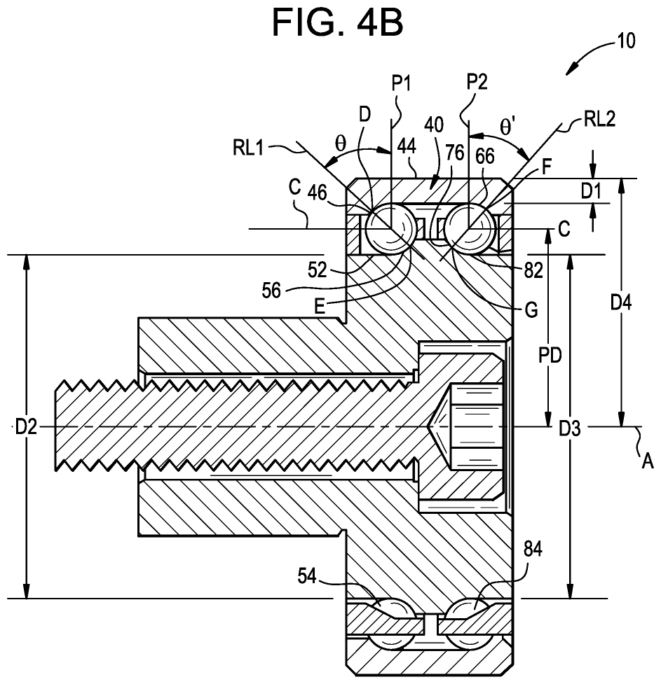

As shown in FIGS. 1-5, gimbal bearing assembly (e.g., an integrated stud ball bearing assembly with precision matched raceway contact angles for consistent and predictable stiffness in a gimbal assembly) is shown and is generally designated by the reference numeral 10. As best shown in FIG. 4A the bearing assembly 10 includes a first ball bearing 30 and a second ball bearing 60. The first ball bearing 30 and the second ball bearing 60 are configured in a tandem configuration. That is, they are axially side to side. The first ball bearing 30 and the second ball bearing 60 are axially fixed relative to each other about a longitudinal axis A.

As shown in FIG. 4A, the ball bearing assembly 10 includes a one piece (i.e., a single integral unitary structure that is common to both the first 30 and the second 60 ball bearings) outer ring 40 that has a first outer race 42, a second outer race 72 and an exterior surface 44. The ball bearing assembly 10 includes a one piece (i.e., a single integral unitary structure that is common to both the first 30 and the second 60 ball bearings) inner ring 50 that has a first inner race 52 and a second inner race 82. The inner ring 50 is integrally formed on a shaft 90 and fixed relative thereto about the longitudinal A and being coaxial with the outer ring 40. The inner ring 50 is coaxially disposed in the outer ring 40. The outer ring 40 is rotatable relative to the inner ring 50 about the longitudinal axis A.

As shown in FIG. 4A, a first plurality of balls 54 is disposed between and in rolling engagement with the first outer race 42 and the first inner race 52. A second plurality of balls 84 is disposed between and in rolling engagement with the second outer race 72 and the second inner race 82.

As shown in FIG. 4B, the first plurality of balls 54 has a first contact angle θ that is defined between a first line P1 perpendicular to the longitudinal axis A and a first reference line RL1 that connects opposing first contact points D, E of the first plurality of balls 54 with the first outer race 42 and the first inner race 52. The second plurality of balls 84 has a second contact angle θ′ that is defined between a second line P2 perpendicular to the longitudinal axis and a second reference line RL2 that connects opposing second contact points F, G of the second plurality of balls 84 with the second outer race 72 and the second inner race 82.

As shown in FIG. 4A, a land 86 separates the first inner race 52 and the second inner race 72.

As shown in FIG. 4A, the first outer race 42 of the outer ring 40 is formed as a radiused portion 46 located proximate to the first plurality of balls 54. The first inner race 52 of the inner ring 50 is formed as a radiused portion 56 located proximate to the first plurality of balls 54. As shown in FIG. 4B, the radiused portions 46 and 56 are positioned symmetrically about the first reference line RL1.

As shown in FIG. 4A, the second inner race 82 of the inner ring 50 is formed as a radiused portion 76 located proximate to the second plurality of balls 84. The second outer race 72 of the outer ring 40 is formed as a radiused portion 66 located proximate to the second plurality of balls 84. As shown in FIG. 4B, the radiused portions 46 and 56 are positioned symmetrically about the second reference line RL2.

In a preferred embodiment, the first contact angle θ and the second contact angle θ′ are both about 30 degrees. In one embodiment, the first contact angle θ and/or the second contact angle θ′ is about 25 degrees to about 35 degrees. In one embodiment, the first contact angle θ and/or the second contact angle θ′ is about 27 degrees to about 33 degrees. In one embodiment, the first contact angle θ and/or the second contact angle θ′ is about 29 degrees to about 31 degrees. The first contact angle θ and the second contact angle θ′ are configured to maximize performance and stiffness of the bearing assembly 10.

As shown in FIG. 4A, the inner ring 50 is machined integrally with the shaft 90. The shaft 90 extends between a first end 91 and a second end 96. A flange 92 extends radially outward from the shaft 90 and extends axially from the first end 91 toward the second end and terminates between the first end 91 and the second end 96. The first ball bearing 30 and the second ball bearing 60 are located axially adjacent to one another and are disposed on the flange 92 of the shaft 90 proximate to the first end 91 thereof.

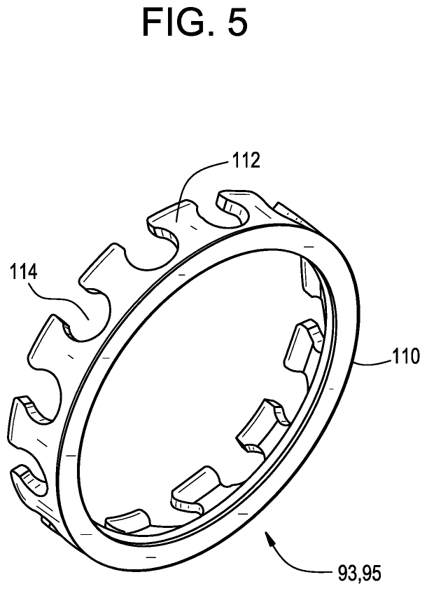

After the bearings 30, 60 are disposed on the flange 92 of the shaft 90, a first cage 93 is received in an aperture 93A between the first inner race 52 and the outer ring 40 to inhibit axial movement of the balls 54 relative to the shaft 90, to space the balls 54 apart from one another and to equalize the load carried by each of the balls 54. Likewise, a second cage 95 is received in an aperture 93B between the second inner race 82 and the outer ring 40 to inhibit axial movement of the balls 84 relative to the shaft 90, to space the balls 84 apart from one another and to equalize the load carried by each of the balls 84. As shown in FIG. 5, the cages 93, 95 each have a ringed flat outer portion 110, and a series of spaced apart prongs 112 projecting therefrom. The prongs 112 are separated by radiused apertures 114 each sized to fit one of the plurality of balls 54, 84 therein. The cages 93, 95 are sized to fit into apertures 93A, 93B, respectively.

The shaft 90 includes an axial face 94 at the first end 91 perpendicular to the longitudinal axis A. The face 94 has a countersunk bore 98 configured to receive a fastener 100 (e.g., a screw or bolt) including a socket 99, or the like, for fixing the shaft 90 about the longitudinal axis A. The fastener 100 further includes a plurality of threads 97 on a radial outside surface 97A of the fastener 100. In this way, the fastener can be received in a bore (not shown) comprising a complementary thread pattern, or can similarly be received in a nut or the like having a complementary thread pattern. By attaching the fastener to a structure, the shaft 90 is fixed, thus allowing the outer ring 40 and bearings 30, 60 to rotate about the longitudinal axis A.

In reference to the embodiment shown in FIGS. 1-5, although the ball bearing assembly 10 comprises a first ball bearing 30 and a second ball bearing 60, the present invention is not limited in this regard and, as will be appreciated by a person of ordinary skill in the art, many different configurations may be employed. For example, the present invention may by practiced using a ball bearing assembly having a single row of roller or ball bearings. Or, for example, the present invention may be practiced using a cam follower having a ball bearing wherein a one outer ring defines a first outer race and a second outer race defines a second outer race, or where one inner ring defines a first inner raceway and a second raceway.

In the embodiment shown in FIGS. 1-5, the outer ring 40 and the shaft 90 are manufactured from AISI 440C stainless steel that is through hardened. The first plurality of balls 54 and the second plurality of balls 84 are manufactured from AISI 440C stainless steel. In the embodiment shown, the balls 54, 84 are separated by the cages 93, 95. The cages 93, 95 can are made from an acetal resin. It should also be understood that the present invention is not limited to balls, as other types of rolling elements may be employed with the present invention.

Although specific materials are disclosed herein, a person of ordinary skill in the art and familiar with this disclosure will understand that the present invention is not limited in this regard, and that other materials may be used with the present invention.

As shown in FIG. 4B, the first inner race 52 and the second inner race 82 have a common inner race outside diameter D2, D3 which are about equal to one another. Thus a ratio of the inner race outside diameter D2 to the inner race outside diameter D3 is about 1.000.

As shown in FIG. 4B, an outer ring outside diameter D4 of the outer ring 40 is defined between an exterior surface 44 of the outer ring 40 and the longitudinal axis A. A ratio of the outer ring outside diameter D4 to the pitch diameter PD is about 120% to about 140%.

A shown in FIG. 4B. the first plurality of balls 54 has a pitch diameter PD defined by a distance between the longitudinal axis A and a ball central axis C. A ratio of the pitch diameter PD to a thickness D1 of the outer ring 40 being about 600% to about 800%.

In one embodiment, the first outer race 42 and the second outer race 72 are configured to impart an axial preload of about 10 pounds to about 35 pounds to the first of balls 54 against the first inner race 52 and to the second plurality of balls 84 against the second inner race 82. In one embodiment, the first outer race 42 and the second outer race 72 are configured to impart an axial preload of about 15 pounds to about 30 pounds to the first of balls 54 against the first inner race 52 and to the second plurality of balls 84 against the second inner race 82. Referring to FIGS. 4A and 4B, the axial preload is established by setting the axial distance between the radiused portion 56 at point E and the radiused portion 76 at point G on the inner ring 50; and or setting the distance between the radiused portion 46 at point D and the radiused portion 66 at point F on the outer ring 40. For example, the axial preload is increased when the distance between point E and point G is increased; and/or the axial preload is increased when the distance between points D and point F is decreased, as part of the machining process to form the inner ring 50 and the outer ring 40.

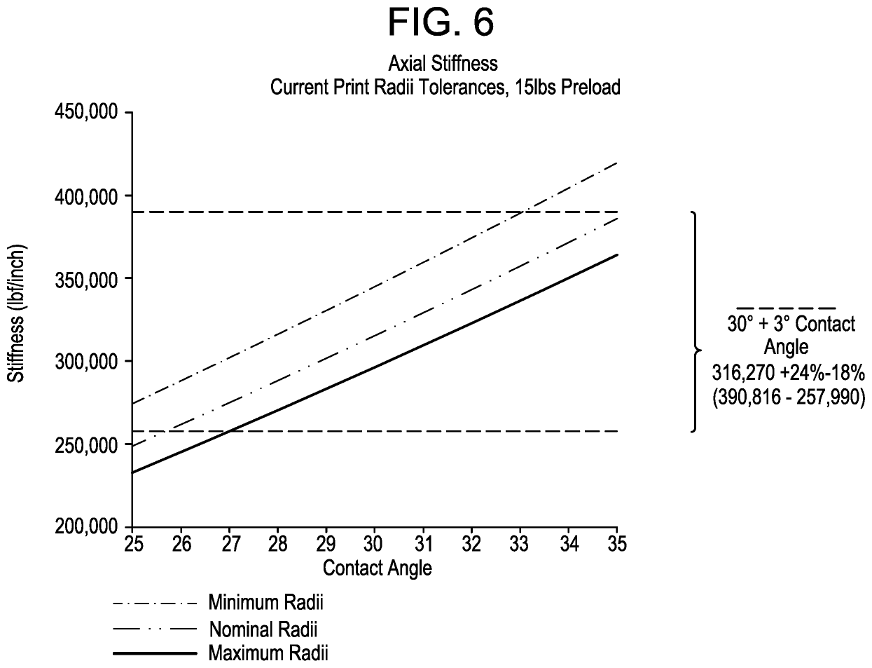

Referring FIGS. 6-8, the stiffnesses of the bearing 10 are shown to illustrate the improvement of the present invention compared to known bearing assemblies. The gimbal bearing assembly is axially preloaded to between about 15 lbs and 30 lbs, thus having preloaded contact angles θ, θ′ for outer and inner raceways of between about 27 degrees and 33 degrees. This allows the bearing stiffness in axial, radial, and moment axes to be more tightly controlled than a bearing without a contact angle tolerance in conjunction with a preload tolerance.

For example, FIG. 6 illustrates the axial stiffness as a function of contact angle based on 15 lbs of axial preload applied to the bearing assembly 10. The bearing assembly 10 of the present invention that has the first and second contact angles θ, θ′ of 30 degrees plus or minus 3 degrees exhibits an improved (i.e., compared to prior art bearings) axial stiffness of 316,270 lbf/in plus 24%, minus 18% with a minimum axial stiffness of 257,990 lbf/in when the first and second contact angles θ, θ′ are 27 degrees and a maximum axial stiffness of 390,810 lbf/in when the first and second contact angles θ, θ′ are 33 degrees.

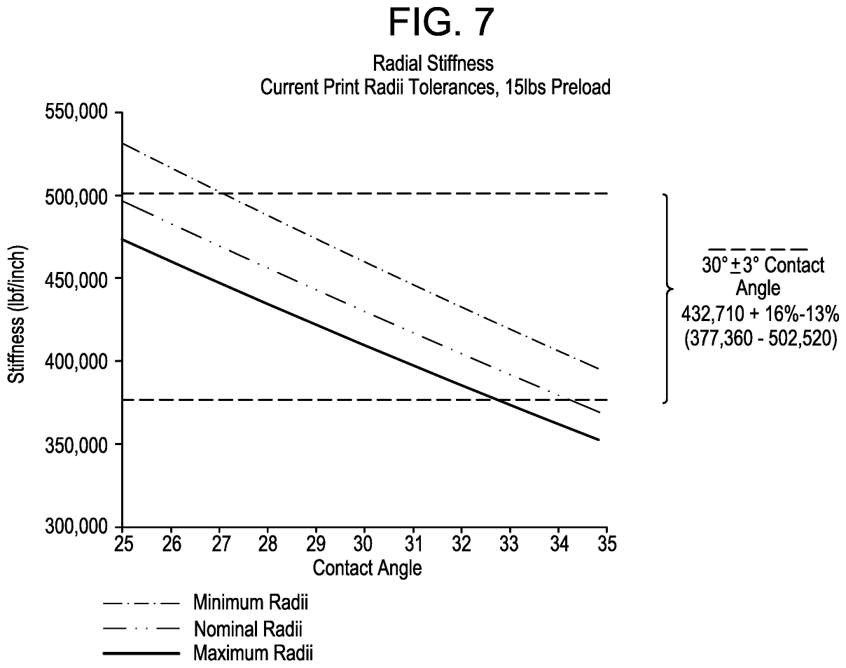

FIG. 7 illustrates the radial stiffness as a function of contact angle based on 15 lbs of axial preload applied to the bearing assembly 10. The bearing assembly 10 of the present invention that has the first and second contact angles θ, θ′ of 30 degrees plus or minus 3 degrees exhibits an improved (i.e., compared to prior art bearings) radial stiffness of 432,710 lbf/in plus 16%, minus 13% with a minimum radial stiffness of about 377,360 lbf/in when the first and second contact angles θ, θ′ are 33 degrees and a maximum a radial stiffness of 502,520 lbf/in lbf/in when the first and second contact angles θ, θ′ are 27 degrees.

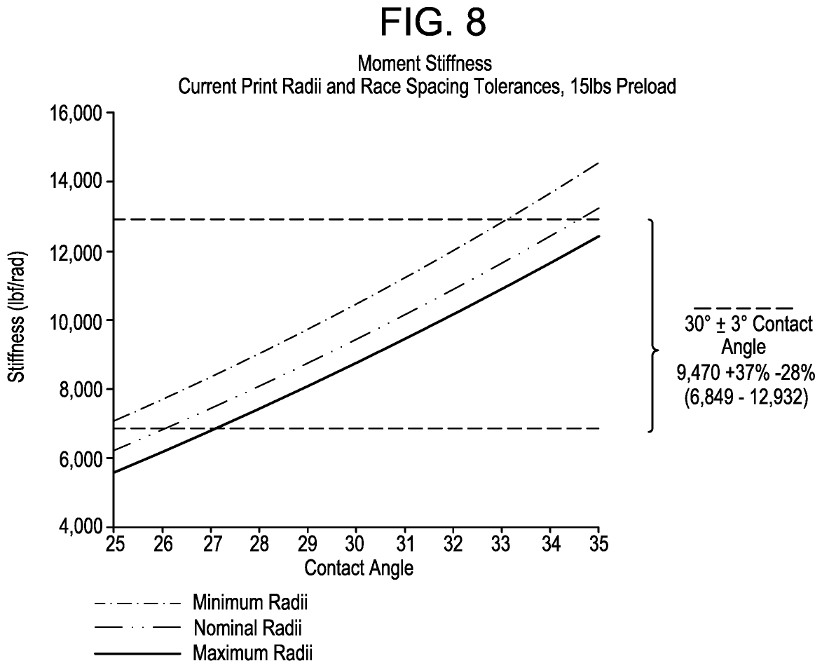

FIG. 8 illustrates the moment stiffness as a function of contact angle based on 15 lbs of axial preload applied to the bearing assembly 10. The bearing assembly 10 of the present invention that has the first and second contact angles θ, θ′ of 30 degrees plus or minus 3 degrees exhibits an improved (i.e., compared to prior art bearings) moment stiffness of 9,470 in-lbf/rad plus 37%, minus 28% with a minimum moment stiffness of about 6,849 in-lbf/rad when the first and second contact angles θ, θ′ are 27 degrees and a maximum a moment stiffness of 12,932 in-lbf/rad when the first and second contact angles θ, θ′ are 33 degrees. The improved stiffness (i.e., axial, radial and moment) demonstrate that the bearing assembly 10 of instant invention yields improved stiffness performance compared to prior art bearings, leading to more consistent and predicable results when using the instant ball bearing assemblies 10 in stiffness critical applications.

Through testing and analysis, the inventors surprisingly discovered that axial and moment stiffness increase with the increasing contact angles θ, θ′, whereas moment stiffness decreases with increasing contact angles θ, θ′. Thus, the ranges of contact angles disclosed herein represent an optimum range or magnitude to maximize axial, radial and moment stiffnesses.

While the present disclosure has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A ball bearing assembly comprising:
a one piece outer ring having a first outer race, a second outer race and an exterior surface;
a one piece inner ring having a first inner race and a second inner race, the inner ring being integrally formed on a shaft and fixed relative thereto about a longitudinal axis A and being coaxial with the outer ring;
a first plurality of balls disposed between and in rolling engagement with the first outer race and the first inner race;
a second plurality of balls disposed between and in rolling engagement with the second outer race and the second inner race;
the outer ring being rotatable relative to the inner ring about the longitudinal axis A;
the first plurality of balls having a first contact angle θ between a first line P1 perpendicular to the longitudinal axis and a first reference line RL1 that connects opposing first contact points D, E of the first plurality of balls with the first outer race and the first inner race; and
the second plurality of balls having a second contact angle θ′ between a second line P2 perpendicular to the longitudinal axis and a second reference line RL2 that connects opposing second contact points F, G of the second plurality of balls with the second outer race and the second inner race.

2. The ball bearing assembly of claim 1, wherein at least one of the first contact angle θ and the second contact angle θ′ is about 25 degrees to about 35 degrees.

3. The ball bearing assembly of claim 1, wherein at least one of the first contact angle θ and the second contact angle θ′ is about 27 degrees to about 33 degrees.

4. The ball bearing assembly of claim 1, wherein at least one of the first contact angle θ and the second contact angle θ′ is about 29 degrees to about 31 degrees.

5. The ball bearing assembly of claim 1, wherein the first outer race and the second outer race are configured to impart an axial preload of about 10 pounds to about 35 pounds to the first of balls against the first inner race and to the second plurality of balls against the second inner race.

6. The ball bearing assembly of claim 1, wherein the first outer race and the second outer race are configured to impart an axial preload of about 15 pounds to about 30 pounds to the first of balls against the first inner race and to the second plurality of balls against the second inner race.

7. The ball bearing assembly of claim 1, wherein the first plurality of balls has a pitch diameter PD defined by a distance between the longitudinal axis A and a ball central axis C, a ratio of the pitch diameter PD to a thickness D1 of the outer ring being about 600% to about 800%.

8. The ball bearing assembly of claim 1, wherein an outer ring outside diameter D4 of the outer ring defined between an exterior surface of the outer ring and the longitudinal axis A, and a ratio of the outer ring outside diameter D4 to the pitch diameter PD is about 120% to about 140%.

9. The ball bearing assembly of claim 1, wherein the first inner race and the second inner race have a common inner race outside diameter D2.

10. The ball bearing assembly of claim 3, wherein the ball bearing assembly has an axial stiffness of about 257, 990 lbf/in to about 390,810 lbf/in.

11. The ball bearing assembly of claim 3, wherein the ball bearing assembly has a radial stiffness of about 377,360 lbf/in to about 502,520 lbf/in.

12. The ball bearing assembly of claim 3, wherein the ball bearing assembly has a moment stiffness of about 6,849 in-lbf/rad to about 12,932 in-lbf/rad.
